(19) United States
(12) Patent Application Publication
(10) Pub. No.: US 2026/0112754 A1
(43) Pub. Date: Apr. 23, 2026

(54) BATTERY CELL STACKING APPARATUS

(71) Applicants: Hyundai Motor Company, Seoul (KR); Kia Corporation, Seoul (KR)

(72) Inventors: Jong Min Park, Hwaseong (KR); Young Seok Lee, Hwaseong (KR); Dong Ho Kwak, Hwaseong (KR); Sang Uk Jeon, Hwaseong (KR); Jun Hyeok Bae, Hwaseong (KR)

(21) Appl. No.: 19/309,173

(22) Filed: Aug. 25, 2025

(30) Foreign Application Priority Data
Oct. 18, 2024 (KR) 10-2024-0143441
May 27, 2025 (KR) 10-2025-0068656

(51) Int. Cl. H01M 50/244; B65G 54/02; B65G 57/03; B65G 57/04

(52) U.S. Cl. CPC H01M 50/244; B65G 54/02; B65G 57/035; B65G 57/04; B65G 2201/0267; B65G 2207/28

(57) ABSTRACT

A battery cell stacking apparatus includes a skid to hold parts, a linear conveyor that moves the skid forward, and a linear shuttle that moves the skid from side to side. Arranged along the shuttle's path are three types of loading equipment. A first and a second loading apparatus work to alternately stack battery cells onto the skid. A separate third loading apparatus places protective pads between the layers of cels. The conveyor and shuttle work together to move the kid to each piece of equipment in sequence. The system can also feature a lifting apparatus to raise the finished stack and an elevator to return empty skids.

### CROSS-REFERENCE TO RELATED APPLICATION

This application claims, under 35 U.S.C. § 119(a), the benefit of Korean Provisional Patent Application No. 10-2024-0143441 filed on Oct. 18, 2024, and Korean Patent Application No. 10-2025-0068656 filed on May 27, 2025, the entire contents of which are incorporated herein by reference.

### BACKGROUND

### Technical Field

The present disclosure relates to a battery cell stacking apparatus. More particularly, the present disclosure relates to a battery cell stacking apparatus capable of stacking battery cells at high speeds using a linear motion system (LMS).

### Background

Generally, a battery module assembly (BMA) includes a plurality of battery cells stacked on one another, pads stacked between the plurality of battery cells, and end plates brought into close contact with the outer surface of the outermost stacked battery cells.

The pad may be made of an elastically deformable polyurethane material to absorb swelling deformation of the battery cell. Here, “swelling” refers to a phenomenon where the battery cell swells due to a pressure created when the lithium ion electrolyte in the battery cell evaporates.

In the past, there were problems in that the number of assembly processes and assembly costs were excessively high, because an index component divided into five areas for stacking battery cells and pads, two or more multi-joint robots, a hot-melt application gun and the like were inefficiently arranged, requiring nine or more continuous processes.

The above information disclosed in this Background section is only for enhancement of understanding of the background of the present disclosure, and therefore it may contain information that does not form the related art that is already known to a person of ordinary skill in the art.

### SUMMARY

The present disclosure has been made in an effort to solve the above-described problems associated with the related art, and various embodiments of the present disclosure are directed to providing a battery cell stacking apparatus configured to repeatedly perform a process of alternately stacking battery cells within a skid by a first loading apparatus and a second loading apparatus and a process of stacking pads by a third loading apparatus while moving the skid along a predetermined path such as forward, rearward, left, and right directions along a linear conveyor and a linear shuttle, maximizing productivity for stacking battery cells.

To achieve said embodiments, the present disclosure provides a battery cell stacking apparatus including a skid having a structure defining a space in the skid, wherein battery cells and pads are stacked in the space, a linear conveyor configured to move the skid forward, a linear shuttle arranged to be movable left and right in a predetermined section of the linear conveyor and configured to move the skid left and right, a first loading apparatus and a second loading apparatus arranged at a front end portion of the linear conveyor and opposite sides of the linear shuttle, respectively, and configured to alternately stack the battery cells within the skid, and a third loading apparatus arranged at a predetermined distance from one side portion of the linear shuttle and configured to stack the pads between the battery cells stacked within the skid.

The skid may include a moving plate movably mounted on the linear conveyor, a support plate fixedly mounted on one side portion of the moving plate, and a pressure plate forward-rearward movably mounted on another side portion of the moving plate and configured to press a side portion of battery cells stacked on the moving plate toward the support plate

Moreover, to configure the skid and the linear conveyor as a linear motor, magnets may be attached to the moving plate of the skid and coils may be placed in the linear conveyor.

Moreover, a drive cylinder connected to the pressure plate to move the pressure plate forward and rearward may be mounted on the moving plate.

A first battery cell alignment plate on which battery cells to be picked up by the first loading apparatus are aligned at a predetermined interval may be arranged at one side of the front end portion of the linear conveyor.

Moreover, a second battery cell alignment plate on which battery cells to be picked up by the second loading apparatus are aligned at a predetermined interval may be arranged at another side of the front end portion of the linear conveyor.

The battery cell stacking apparatus of the present disclosure may further include a driving device configured to reciprocate the linear shuttle, on which the skid is seated, in the left-right direction. The driving device may include a servo motor mounted at a bottom of the linear shuttle, a pinion mounted on an output shaft of the servo motor, and a rack arranged at a predetermined position below the linear shuttle.

Moreover, stoppers brought into close contact with one end and another end of the skid may be positioned at opposite ends of the linear shuttle, respectively, and a pusher that is raised and lowered by driving of a cylinder may be connected to the stopper.

The first loading apparatus, the second loading apparatus, and the third loading apparatus each may include a linear frame configured to move along a linear rail, a plurality of grippers mounted at a lower portion of the linear frame, and vacuum suction cups mounted at a bottom of the gripper and configure to vacuum-suction a battery cell or a pad.

Moreover, a pad magazine on which pads are loaded to be picked up by the third loading apparatus may be arranged at a rear of the third loading apparatus.

Moreover, a hot-melt application gun configured to apply a hot-melt adhesive on the pads stacked in the skid during the linear shuttle moving left and right may be arranged above the linear shuttle.

A lifting apparatus configured to support and lift the battery cells stacked in the skid through open holes formed in the linear shuttle and in the skid, respectively, may be arranged below the linear shuttle.

The lifting apparatus may include a fixed frame fixed at a position below the linear shuttle, a lifting frame arranged below the fixed frame, a drive motor mounted on the lifting frame, a lead screw mounted at a bottom of the fixed frame and engaged with a gearbox of the drive motor, and a lifting bar mounted on the lifting frame and configured to support and lift the battery cells stacked in the skid while being raised and lowered through the open holes formed in the linear shuttle and the skid.

The battery cell stacking apparatus of the present disclosure may further include a first elevator arranged at a rear end portion of the linear conveyor and configured to lower the skid with an empty interior as the battery cells that have completed being stacked in the skid are picked up by a robot, a lower linear conveyor arranged below the linear conveyor and configured to return the skid with an empty interior discharged from the first elevator to a position below the front end portion of the linear conveyor, and a second elevator configured to raise the skid with an empty interior, which has returned to the position below the front end portion of the linear conveyor along the lower linear conveyor, to an upper surface position of the front end portion of the linear conveyor.

Also provided is a battery cell stacking apparatus comprising a skid configured to support a stack of battery cells and pads; a plurality of loading apparatuses configured to deposit battery cells and pads onto the skid to form the stack; and a servo-controlled vertical lift mechanism operatively coupled to the skid, wherein the vertical lift mechanism is configured to adjust an elevation of the skid downward after a battery cell or a pad is deposited thereby maintaining a top surface of the stack at a substantially constant vertical height for receiving a subsequent battery cell or pad.

The servo-controlled vertical lift mechanism may adjust the elevation of the skid based on a predetermined thickness of the battery cell or the pad being deposited.

Also provided is a battery cell stacking apparatus comprising a conveyance system configured to move a skid to a plurality of loading stations; and at least one loading apparatus positioned at one of the loading stations, the at least one loading apparatus comprising a gripper for picking and placing a battery cell, wherein the gripper includes a multi-axis compliance mechanism configured to cushion the battery cell against forces along at least one vertical axis and at least one horizontal axis during placement of the battery cell onto the skid.

The multi-axis compliance mechanism may include a plurality of spring-loaded cushions that provide compliance to prevent shock-induced damage to the battery cel as it makes contact with an adjacent component in the skid.

In another embodiment, vehicles are provided that comprise an apparatus as disclosed herein.

Other aspects and embodiments of the present disclosure are discussed infra.

The above and other features of the present disclosure are discussed infra.

### BRIEF DESCRIPTION OF THE DRAWINGS

The above and other features of the present disclosure will now be described in detail with reference to various embodiments thereof illustrated in the accompanying drawings which are given herein below by way of illustration only, and thus are not limitative of the present disclosure, and wherein:

FIG. 1 is a perspective view illustrating a battery cell stacking apparatus according to some embodiments of the present disclosure;

FIG. 2 is a perspective view illustrating a skid of the battery cell stacking apparatus according to some embodiments of the present disclosure;

FIG. 3 is a front view illustrating a skid of the battery cell stacking apparatus according to some embodiments of the present disclosure;

FIG. 4 is a bottom view illustrating a skid of the battery cell stacking apparatus according to some embodiments of the present disclosure;

FIG. 5 is a schematic diagram illustrating that a skid and a first linear rail of the battery cell stacking apparatus according to some embodiments of the present disclosure are configured as a linear motor;

FIG. 6 is a front view illustrating a gripper commonly used in a first loading apparatus, a second loading apparatus, and a third loading apparatus of the battery cell stacking apparatus according to some embodiments of the present disclosure;

FIG. 7 is a side view illustrating a gripper commonly used in a first loading apparatus, a second loading apparatus, and a third loading apparatus of the battery cell stacking apparatus according to some embodiments of the present disclosure;

FIG. 8 is a front view illustrating a linear shuttle of the battery cell stacking apparatus according to some embodiments of the present disclosure;

FIG. 9 is a front view illustrating a linear shuttle lifting apparatus of the battery cell stacking apparatus according to some embodiments of the present disclosure;

FIG. 10 is a front view illustrating a trajectory along which a skid circulates in the battery cell stacking apparatus according some embodiments of to the present disclosure;

FIG. 11 is a plan view illustrating a state in which a skid configured to stack battery cells is arranged at a front end portion of a linear conveyor of the battery cell stacking apparatus according to some embodiments of the present disclosure;

FIG. 12 and FIG. 13 are plan views illustrating a motion in which battery cells are alternately stacked in a skid by a first loading apparatus and a second loading apparatus of the battery cell stacking apparatus according to some embodiments of the present disclosure;

FIG. 14 is a plan view illustrating a motion in which pads are stacked between battery cells in a skid by a third loading apparatus of the battery cell stacking apparatus according to some embodiments of the present disclosure; and

FIG. 15 is a plan view illustrating a motion in which a skid in which stacking of battery cells and pads has been completed by the battery cell stacking apparatus according to some embodiments of the present disclosure is being discharged.

It should be understood that the appended drawings are not necessarily to scale, presenting a somewhat simplified representation of various features illustrative of the basic principles of the present disclosure. The specific design features of the present disclosure, including, for example, specific dimensions, orientations, locations, and shapes, will be determined in part by the particular intended application and usage environment.

In the figures, the reference numerals refer to the same or equivalent parts of the present disclosure throughout the several figures of the drawing.

### DETAILED DESCRIPTION

Descriptions of specific structures or functions presented in the embodiments of the present disclosure are merely exemplary for the purpose of explaining the embodiments according to the concept of the present disclosure, and the embodiments according to the concept of the present disclosure may be configured in various forms. In addition, the described embodiments are not intended to be limiting. The scope of the disclosure include all modifications, equivalents, and substitutes that fall within the spirit and scope of the claims.

In this specification, the terms “first,” “second,” etc. may be used to describe various components, but the components are not limited by these terms. These terms are only used to distinguish one component from another. For example, a first component could be termed a second component, and similarly, a second component could be termed a first component, without departing from the scope of various embodiments of the present disclosure.

It will be understood that, when a component is referred to as being “connected to” or “brought into contact with” another component, the component may be directly connected to or brought into contact with the other component, or intervening components may also be present. In contrast, when a component is referred to as being “directly connected to” or “brought into direct contact with” another component, there is no intervening component present. Other terms used to describe relationships between components should be interpreted in a like fashion (e.g., “between” versus “directly between,” “adjacent” versus “directly adjacent,” etc.).

Throughout the specification, like reference numerals indicate like components. The terminology used herein is for the purpose of illustrating embodiments and is not intended to limit the present disclosure. In this specification, the singular form includes plural forms unless specified otherwise. The terms “comprises” and/or “comprising” used in this specification mean that the cited component, step, operation, and/or element does not exclude the presence or addition of one or more of other components, steps, operations, and/or elements.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The term “skid” herein refers to a transportable, process-specific pallet or fixture designed to securely hold and precisely locate one or more workpieces, such as battery cells and pads.

The term “substantially constant” herein refers to a condition maintained within a functional tolerance sufficient to prevent operational failure, such as collision or misalignment. For a vertical height, such a tolerance may comprise a deviation of, for example, less than plus or minus 0.5 or 0.1 millimeters for a target position., or alternatively, a deviation of less than 5% of the thickness of a component being added.

The term “alternately stack” herein refers to the sequential process of placing components in a repeating, non-identical order.

Hereinafter, various embodiments of the present disclosure are described in detail with reference to the attached drawings.

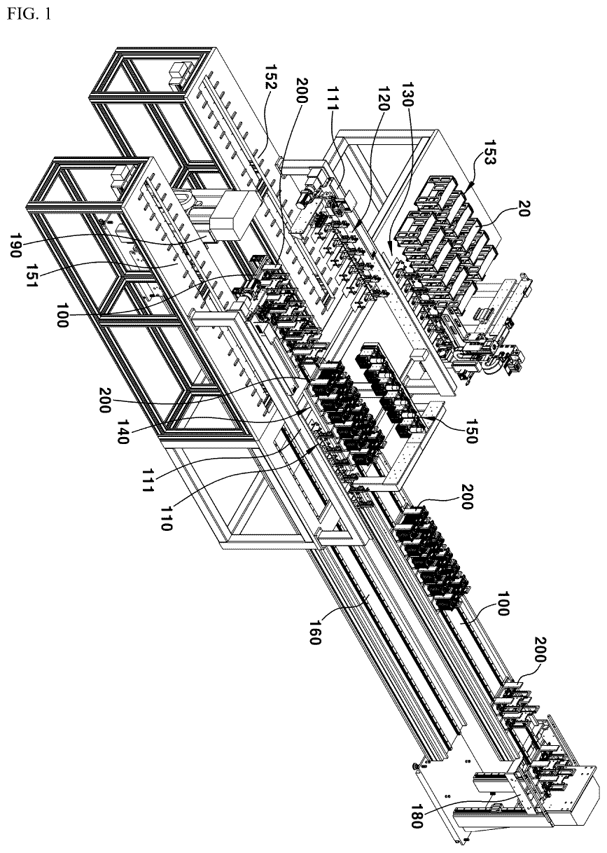

FIG. 1 is a perspective view illustrating a battery cell stacking apparatus according to the present disclosure.

The battery cell stacking apparatus according to the present disclosure includes, as illustrated in FIG. 1, a skid 200 manufactured in a structure having a space in which battery cells and pads are stacked, a linear conveyor 100 having a predetermined length fixedly arranged to serve as a forward movement path of the skid 200, a linear shuttle 140 arranged to be movable left and right in a predetermined section of the linear conveyor 100 and configured to move the skid 200 left and right, a first loading apparatus 110 and a second loading apparatus 120 arranged at a front end portion of the linear conveyor 100 and opposite sides of the linear shuttle 140, respectively, and configured to alternately stack the battery cells within the skid 200, and a third loading apparatus 130 arranged at a predetermined distance from one side portion of the linear shuttle 140 and configured to stack the pads between the battery cells stacked within the skid 200.

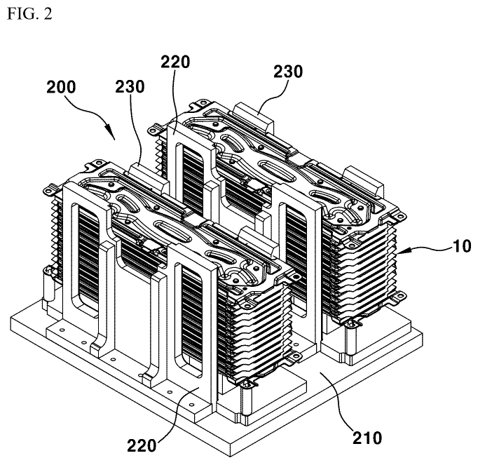

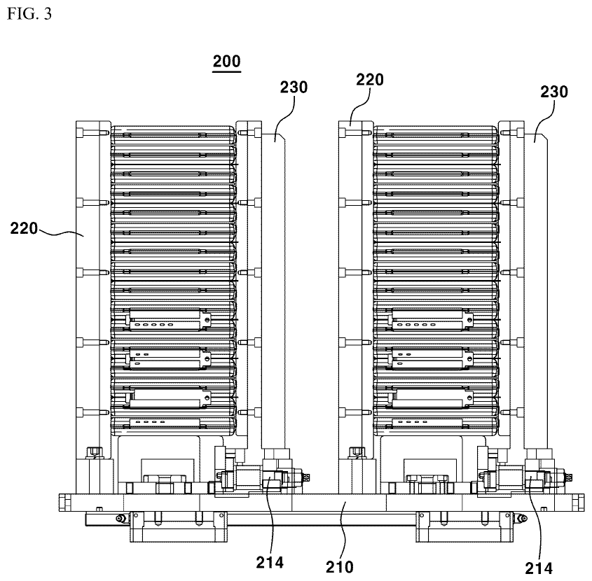

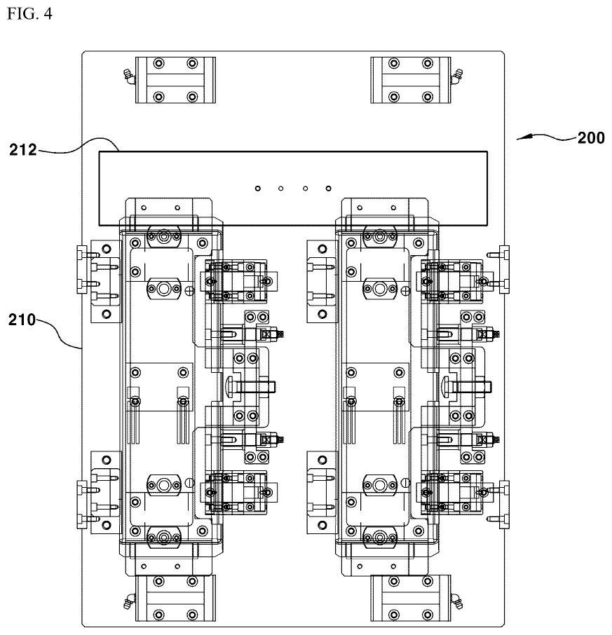

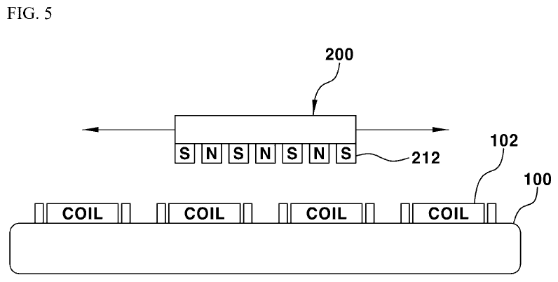

The skid 200 may include, as illustrated in FIGS. 2, 3, and 4, a moving plate 210 movably mounted on the linear conveyor 100, a support plate 220 fixedly mounted on one side portion of the moving plate 210, and a pressure plate 230 forward-rearward movably mounted on another side portion of the moving plate 210 and configured to press a side portion of the battery cells 10 stacked on the moving plate 210 toward the support plate 220. Here, to configure the skid 200 and the linear conveyor 100 as a linear motor, magnets 212 are attached to the moving plate 210 of the skid 200, and coils 102 are placed in the linear conveyor 100, as illustrated in FIG. 5.

In detail, a linear motor is used in a linear motion system (LMS) and is a motor that directly generates a linear motion, unlike a general motor that outputs a rotational force. The linear conveyor 100 with the emplaced coils 102 corresponds to the stator of a general motor, and the moving plate 210 to which the magnets 212 are mounted corresponds to the rotor of a general motor.

Accordingly, a force to linearly move the moving plate 210 is generated by the interaction between the magnetic field generated by the current applied to the coils 102 in the linear conveyor 100 and the magnetic flux generated by the magnets of the moving plate 210, and thus the skid 200 may be linearly moved on the linear conveyor 100.

A drive cylinder 214 is mounted at a predetermined position on the moving plate 210, and a piston rod of the drive cylinder 214 is connected to an outer lower portion of the pressure plate 230 so as to move the pressure plate 230 forward and rearward. The drive cylinder 214 may be a pneumatic cylinder, a hydraulic cylinder, and an electric cylinder to move the piston rod forward and rearward.

Accordingly, when the battery cells 10 are alternately stacked on the moving plate 210 within the skid 200 by the first loading apparatus 110 and the second loading apparatus 120, the pressure plate 230 moves rearward by the rearward movement of the piston rod owing to the driving of the drive cylinder 214, securing a wide stacking passage for the battery cells 10.

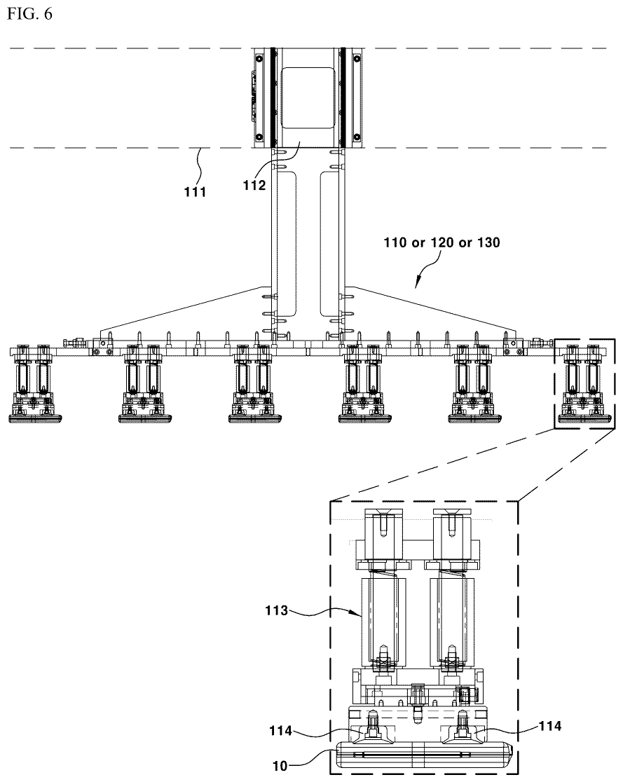

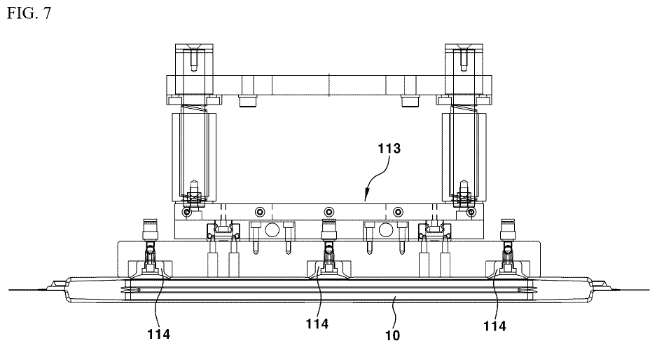

When the alternate stacking of the battery cells 10 on the moving plate 210 within the skid 200 by the first loading apparatus 110 and the second loading apparatus 120 is completed, the pressure plate 230 is moved forward by the forward movement of the piston rod owing to the driving of the drive cylinder 214 and presses the battery cells 10 toward the support plate 220, neatly aligning the battery cells 10 in a straight line in a vertical direction. The first loading apparatus 110, the second loading apparatus 120, and the third loading apparatus 130 may commonly include, as illustrated in FIGS. 6 and 7, a linear frame 112 configured to linearly move along a linear rail 111, a plurality of grippers 113 mounted at a lower portion of the linear frame 112, and vacuum suction cups 114 mounted at a bottom of the gripper 113 and connected to a vacuum providing device (not shown) to vacuum-suction a battery cell 10 or a pad 20.

Preferably, coils may be emplaced in the linear rail 111 and magnets may be mounted on the linear frame 112 so as to configure the linear rail 111 and the linear frame 112 as a linear motor, just as the skid 200 and the linear conveyor 100 are configured as a linear motor.

Here, a first battery cell alignment plate 151 is arranged at one side of the front end portion of the linear conveyor 100. The first battery cell alignment plate 151 aligns battery cells 10 at a predetermined interval to be picked up by a vacuum suction cup 114 f the first loading apparatus 110.

Moreover, a second battery cell alignment plate 152, on which battery cells 10 to be picked up by the vacuum suction cup 114 of the second loading apparatus 120 are aligned at a predetermined interval, is arranged at another side of the front end portion of the linear conveyor 100.

Furthermore, a pad magazine 153, on which pads 20 are loaded to be picked up by the vacuum suction cups 114 of the third loading apparatus 130, is arranged at a rear of the third loading apparatus 130.

Accordingly, as the skid 200 moves along the linear conveyor 100 to the linear shuttle 140, the linear shuttle 140 may perform a series of repeated movements. For example, the linear shuttle 140 may move toward the first loading apparatus 110 to allow an odd-numbered layer of battery cells 10 to be stacked, then move toward the third loading apparatus 130 to allow a pad 20 to be stacked on the battery cells 10.

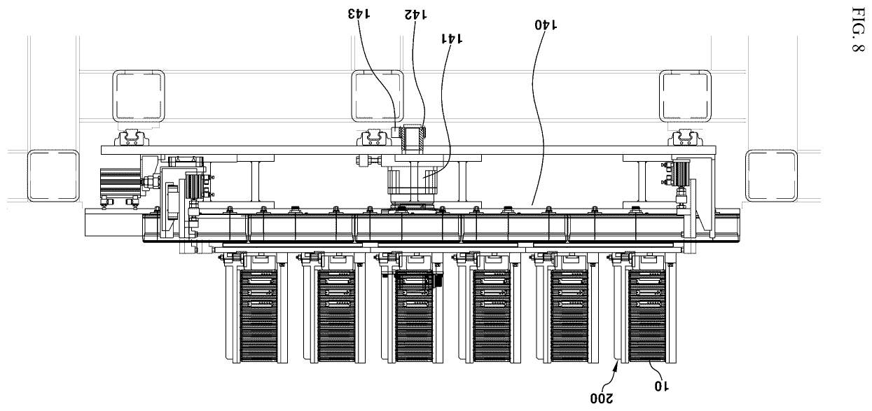

To this end, a driving device is provided to reciprocate the linear shuttle 140, on which the skid 200 is seated, in the left-right direction. The driving device includes, as illustrated in FIG. 8, a servo motor 141 mounted at a bottom of the linear shuttle 140, a pinion 142 mounted on the output shaft of the servo motor 141, and a rack 143, with which the pinion 142 engages, arranged at a predetermined position below the linear shuttle 140.

Accordingly, in response to the servo motor 141 rotating in one direction, the pinion 142 rotates in the one direction and moves along the rack 143, allowing the linear shuttle 140 to linearly move toward the one side. Conversely, in response to the servo motor 141 rotating in another direction, the pinion 142 rotates in the other direction and moves along the rack 143, allowing the linear shuttle 140 to linearly move toward the other side.

Here, the skid 200 may be fixed to the linear shuttle 140 to prevent movement or shaking during reciprocation of the shuttle.

To this end, stoppers 144 brought into close contact with one end and another end of the skid 200 are positioned at opposite ends of the linear shuttle 140, respectively, and a pusher 146 that is raised and lowered by the driving of a cylinder 145 is connected to the stopper 144.

Accordingly, when the pusher 146 rises and pushes the stopper 144 upwards by the driving of the cylinder 145, the stoppers 144 are closely supported on the one end and the other end of the skid 200, respectively, so that the skid 200 may be firmly fixed in place when the linear shuttle 140 reciprocates left and right.

A hot-melt application gun 150 configured to apply a hot-melt adhesive on the pads 20 stacked in the skid 200 while the linear shuttle 140 linearly moves left and right is arranged above the linear shuttle 140.

Accordingly, when the linear shuttle 140 linearly moves toward the other side where the third loading apparatus 130 is located, a hot-melt adhesive to bond a pad 20 to a battery cell 10 stacked in the skid 200 may be applied from the hot-melt application gun 150 to the battery cell 10, or when the linear shuttle 140 linearly moves again from the third loading apparatus 130 to the one side, a hot-melt adhesive to bond a battery cell 10 to the pad 20 stacked in the skid 200 may be applied from the hot-melt application gun 150 to the pad 20.

Meanwhile, because the internal space in the skid 200 in which the battery cells are stacked, that is, the space between the support plate 220 and the pressure plate 230 mounted on the moving plate 210, has a set depth, when the grippers 113 of the first loading apparatus 110 and the second loading apparatus 120 enter the internal space in the skid 200 to stack the battery cells 10 or the gripper 113 of the third loading apparatus 130 enters the internal space in the skid 200 to stack the pads 20, an interference such as the gripper 113 touching the skid 200 may occur, which may damage the battery cells 10.

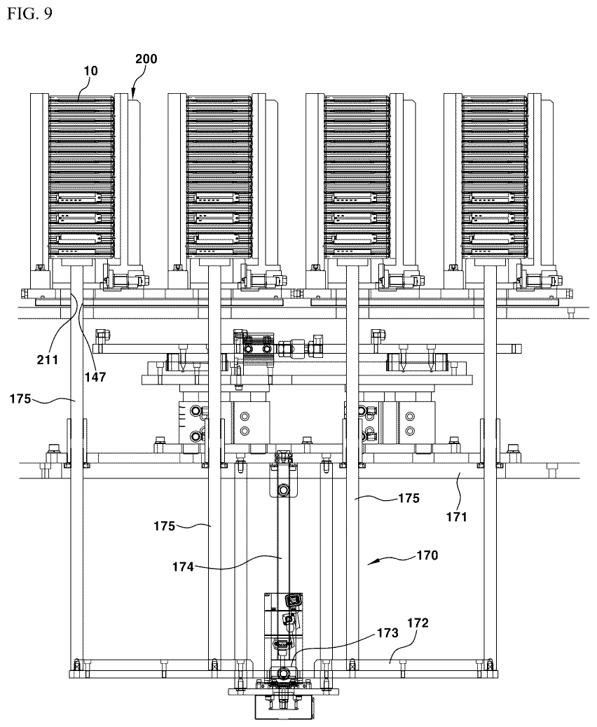

As illustrated in FIG. 9, a lifting apparatus 170 is arranged below the linear shuttle 140. The lifting apparatus 170 is configured to support and lift battery cells 10 stacked on the skid 200 through corresponding open holes 147 and 211 formed in the linear shuttle 140 and the moving plate 20 of the skid 200.

The lifting apparatus 170 may include, as illustrated in FIG. 9, a fixed frame 171 fixed at a position below the linear shuttle 140, a lifting frame 172 arranged below the fixed frame 171, a drive motor 173 mounted on the lifting frame 172, a lead screw 174 mounted at a bottom of the fixed frame 171 and engaged with a gearbox of the drive motor 173, and a lifting bar 175 mounted on the lifting frame 172 and configured to support and lift the battery cells 10 stacked in the skid 200 while being raised and lowered through the open holes 147 and 211 formed in the linear shuttle 140 and in the moving plate 210 of the skid 200, respectively.

Here, the lead screw 174 in a fixed state may be inserted and fastened to a nut body (not shown) in the gearbox of the drive motor 173.

Accordingly, when the nut body rotates in one direction and rises along the lead screw 174 in response to the drive motor 173 rotating in the one direction, the drive motor 173 as well as the lifting frame 172 and the lifting bar 175 also rise and an upper end portion of the lifting bar 175 is positioned at an upper position in the internal space in the skid 200. Therefore, when initially stacking a battery cell 10 in the skid 200, the gripper 113 of the first loading apparatus 110 may easily stack the battery cell 10 on the upper surface of the lifting bar 175 and does not have to enter the internal space in the skid 200.

Moreover, when the nut body rotates in another direction and descends along the lead screw 174 to a set height in response to the drive motor 173 rotating in the other direction, the drive motor 173 as well as the lifting frame 172 and the lifting bar 175 also descend to a set height, and the lifting bar 175 and the battery cell 10 initially stacked on the upper surface of the lifting bar 175 also descend to the same height. Therefore, the gripper 113 of the second loading apparatus 120 may also easily stack a next battery cell 10 on top of the battery cell 10 initially stacked on the upper surface of the lifting bar 175 without having to enter the internal space in the skid 200 to stack the next battery cell 10.

Accordingly, the battery cell 10 stacking operation by the grippers 113 of the first loading apparatus 110 and the second loading apparatus 120 as well as the pad 20 stacking operation by the gripper 113 of the third loading apparatus 130 are performed at a predetermined height position where the gripper 113 does not enter the internal space in the skid 200, and thus the battery cells 10 may be stacked in the skid 200 without damage.

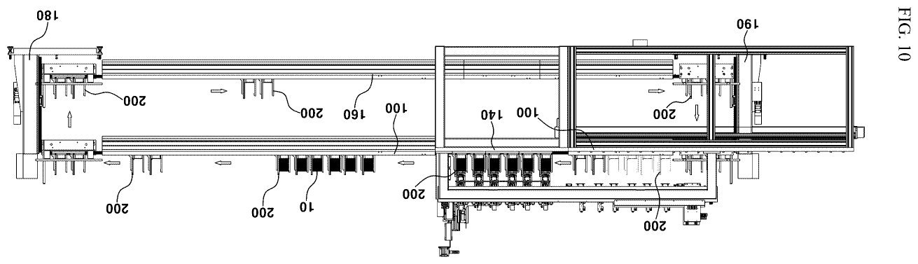

Referring to FIG. 1 and FIG. 10, a first elevator 180 configured to lower the skid 200 with an empty interior as the battery cells 10 that have completed being stacked in the skid 200 are picked up by a robot (not shown) is arranged at a rear end portion of the linear conveyor 100.

Moreover, a lower linear conveyor 160 configured to return the skid 200 with an empty interior discharged from the first elevator 180 to a position below the front end portion of the linear conveyor 100 is arranged below the linear conveyor 100.

Here, as described above, magnets 212 are attached to the moving plate 210 of the skid 200 and coils 102 are emplaced in the lower linear conveyor 160, so that the skid 200 and the lower linear conveyor 160 may also be configured as a linear motor to linearly move the skid 200.

Moreover, a second elevator 190 configured to raise the skid 200 with an empty interior, which has returned to the position below the front end portion of the linear conveyor 100, to an upper surface position of the front end portion of the linear conveyor 100 is arranged at an end portion of the lower linear conveyor 160.

Accordingly, as illustrated in FIG. 10, a motion in which the skid 200 is moved from the front end portion of the linear conveyor 100 to the linear shuttle 140, a motion in which the skid 200 is moved from the linear shuttle 140 to the rear end portion of the linear conveyor 100 after the process of stacking battery cells 10 in the skid 200 by the first loading apparatus 110 and the second loading apparatus 120 and the process of stacking pads 20 between the battery cells 10 by the third loading apparatus 130, a motion in which the skid 200 with an empty interior as the battery cells 10 that have completed being stacked in the skid 200 are picked up by a robot (not shown) is moved to the lower linear conveyor 160 by the first elevator 180, a motion in which the skid 200 with an empty interior is moved along the lower linear conveyor 160 to the second elevator 190, and a motion in which the skid 200 with an empty interior is raised by the second elevator 190 to the upper surface position of the front end portion of the linear conveyor 100 may be repeated.

Hereinafter, the operation flow of the battery cell stacking apparatus according to the disclosed embodiment is sequentially described.

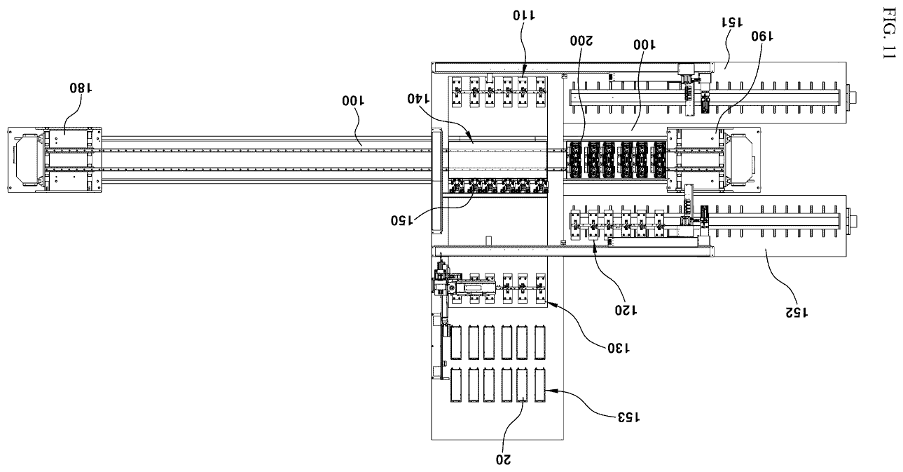

First, as illustrated in FIG. 11, skids 200 with empty interior are aligned in a standby state on the front end portion of the linear conveyor 100.

Next, the skids 200 are moved forward along the linear conveyor 100 and are placed on the linear shuttle 140.

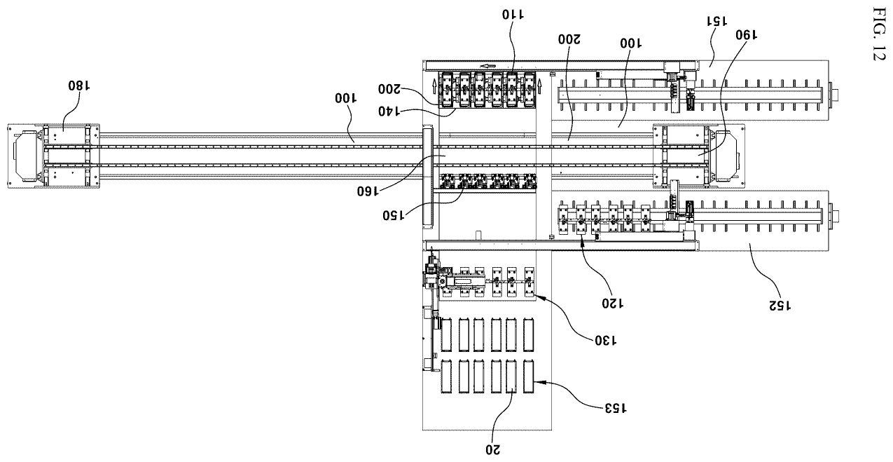

Thereafter, the linear shuttle 140 is linearly moved by a set distance toward one side where the first loading apparatus 110 is located, and as illustrated in FIG. 12, the skids 200 are placed at a position where batteries may be stacked in the skids 200 by the first loading apparatus 110.

Then, the vacuum suction cup 114 of the first loading apparatus 110 adsorbs the battery cells 10 aligned on the first battery cell alignment plate 151, the linear frame 112 of the first loading apparatus 110 moves toward the skids 200 along the linear rail 111 to place the battery cells 10 adsorbed by the vacuum suction cup 114 above the skids 200, and the vacuum suction cup 114 releases the vacuum to place the battery cells 10 corresponding to an odd layer in the skid 200.

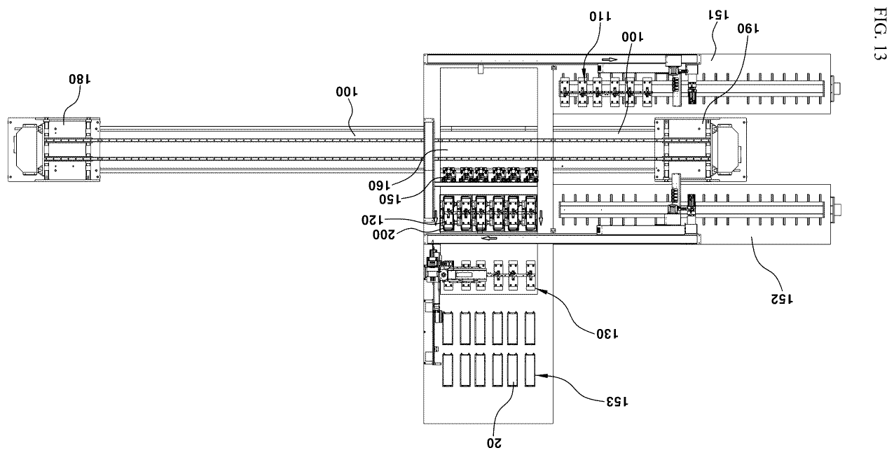

Next, the linear shuttle 140 is linearly moved by a set distance toward another side where the second loading apparatus 120 is located, and the skids 200 are placed at a position where batteries may be stacked by the second loading apparatus 120, as illustrated in FIG. 13.

Then, the vacuum suction cup 114 of the second loading apparatus 120 adsorbs the battery cells 10 aligned on the second battery cell alignment plate 152, the linear frame 112 of the second loading apparatus 120 moves toward the skids 200 along the linear rail 111 to place the battery cells 10 adsorbed by the vacuum suction cup 114 above the skids 200, and the vacuum suction cup 114 releases the vacuum to place the battery cells 10 corresponding to an even layer in the skid 200.

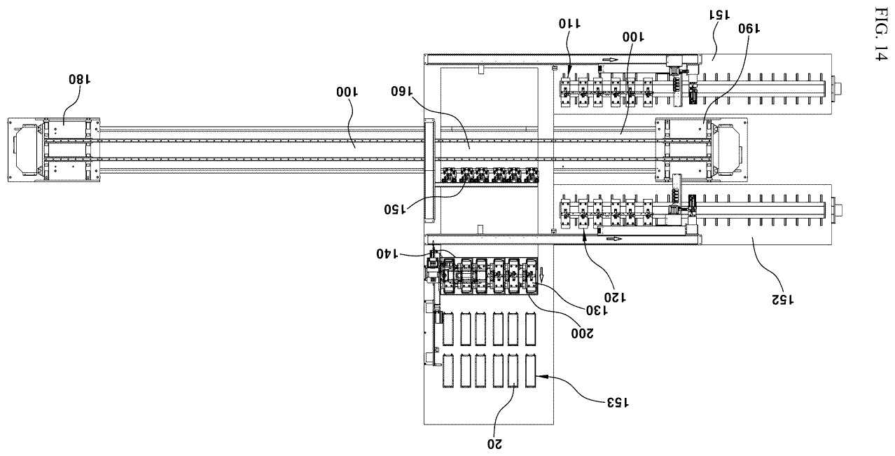

Moreover, as illustrated in FIG. 14, the linear shuttle 140 is linearly moved by a set distance toward the other side where the third loading apparatus 130 is located, and the skids 200 are placed at a position where pads may be stacked by the third loading apparatus 130.

Then, the vacuum suction cup 114 of the third loading apparatus 130 adsorbs the pads 20 loaded on the pad magazine 153 and moves above the battery cells 10 stacked in the skid 200 and then releases the vacuum to place the pads 20 on the battery cells 10 stacked in the skid 200.

Here, when the linear shuttle 140 linearly moves toward the other side where the third loading apparatus 130 is located, a hot-melt adhesive to bond the pad 20 to the battery cell 10 stacked in the skid 200 is applied from the hot-melt application gun 150 to the battery cell 10, or when the linear shuttle 140 linearly moves again from the third loading apparatus 130 to the one side, a hot-melt adhesive to bond a battery cell 10 to the pad 20 stacked in the skid 200 is applied from the hot-melt application gun 150 to the pad 20, allowing the pads 20 to be bonded and fixed between the battery cells 10 by the hot melt adhesive.

As such, a motion of the linear shuttle 140 linearly moving toward one side where the first loading apparatus 110 is located by a set distance so that battery cells 10 corresponding to an odd layer are stacked in the skid 200, a motion of the linear shuttle 140 linearly moving toward another side where the second loading apparatus 120 is located by a set distance so that battery cells 10 corresponding to an even layer are stacked in the skid 200, and a motion of the linear shuttle 140 linearly moving toward the other side where the third loading apparatus 130 is located by a set distance or further so that pads 20 are stacked between the battery cells 10 stacked in the skid 200 are repeated, allowing a set number of battery cells 10 and pads 20 to be easily stacked within the skid 200.

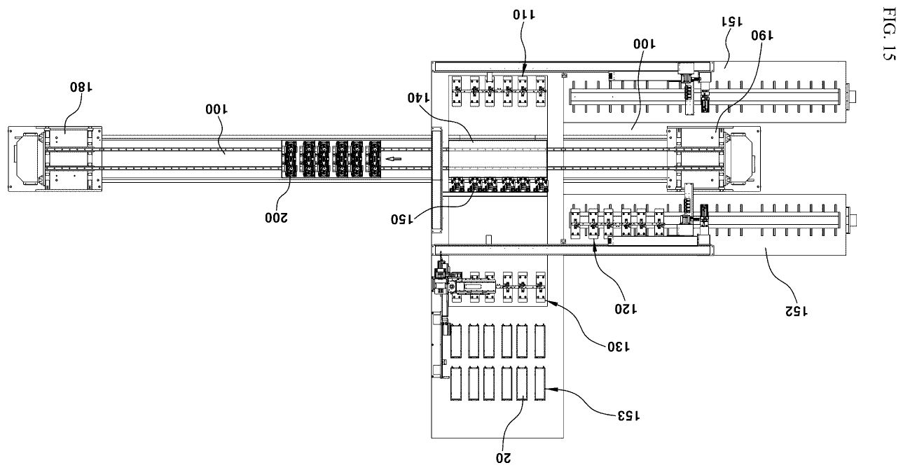

Meanwhile, when completing stacking of a set number of battery cells 10 and pads 20 in the skid 200, the skid 200 is, as illustrated in FIG. 15, linearly discharged from the linear shuttle 140 to the rear end portion of the linear conveyor 100, and the stacked battery cells in the discharged skid 200 may be picked up by a multi-joint robot (not shown) for transport to a next process, and the skid 200, whose interior has become empty accordingly, may return to the upper surface position of the front end portion of the linear conveyor 100 after passing through the first elevator 180, the lower linear conveyor 160, and the second elevator 190 as described above.

As described above, compared to the related art, the number of processes for stacking battery cells 10 is reduced to four including a battery cell stacking process by the first loading apparatus, a battery cell stacking process by the second loading apparatus, a pad stacking process by the third loading apparatus, and an adhesive application process by the hot-melt application gun, maximizing the productivity for stacking battery cells, and the installation area for the battery cell stacking apparatus is reduced, reducing manufacturing costs.

The embodiments described herein may provide several advantages.

First, the number of processes for stacking battery cells may be reduced, for example, from nine to four, which can increase manufacturing productivity and reduce the physical footprint and cost of the apparatus.

Second, the apparatus may be configured to stack various types of battery cells, including pouch, square, and cylindrical cells.

Third, the linear motion system enables high-speed operation of the linear conveyor and shuttle, proceeding the battery cell stacking process quickly.

Fourth, battery cells are stacked within a skid, which is a type of moving tray, improving the stacking quality of the battery cells.

The scope of the present disclosure is not limited to the above-described embodiment, and various modifications and improvements by those skilled in the art based on the basic concept of the present disclosure as defined in the claims below will also be included in the scope of the present disclosure.

What is claimed is:

1. A battery cell stacking apparatus comprising:
a skid having a structure defining a space in which battery cells and pads are stacked;
a linear conveyor configured to move the skid forward;
a linear shuttle arranged to be movable left and right in a predetermined section of the linear conveyor to move the skid left and right;
a first loading apparatus and a second loading apparatus arranged at a front end portion of the linear conveyor and opposite sides of the linear shuttle, respectively, and configured to alternately stack the battery cells within the skid; and
a third loading apparatus arranged at a predetermined distance from one side portion of the linear shuttle and configured to stack the pads between the battery cells stacked within the skid.

2. The battery cell stacking apparatus of claim 1, wherein the skid comprises:
a moving plate movably mounted on the linear conveyor;
a support plate fixedly mounted on one side portion of the moving plate; and
a pressure plate configured to move forward and rearward on another side portion of the moving plate and press a side portion of the battery cells stacked on the moving plate toward the support plate.

3. The battery cell stacking apparatus of claim 2, wherein, to configure the skid and the linear conveyor as a linear motor, magnets are attached to the moving plate of the skid and coils are emplaced in the linear conveyor.

4. The battery cell stacking apparatus of claim 2, wherein a drive cylinder connected to the pressure plate to move the pressure plate forward and rearward is mounted on the moving plate.

5. The battery cell stacking apparatus of claim 1, wherein a first battery cell alignment plate, on which battery cells to be picked up by the first loading apparatus are aligned at a predetermined interval, is arranged at one side of the front end portion of the linear conveyor.

6. The battery cell stacking apparatus of claim 5, wherein a second battery cell alignment plate, on which battery cells to be picked up by the second loading apparatus are aligned at a predetermined interval, is arranged at another side of the front end portion of the linear conveyor.

7. The battery cell stacking apparatus of claim 1, further comprising a driving device configured to reciprocate the linear shuttle, on which the skid is seated, in left-right direction, wherein the driving device comprises a servo motor mounted at a bottom of the linear shuttle, a pinion mounted on an output shaft of the servo motor, and a rack arranged at a predetermined position below the linear shuttle.

8. The battery cell stacking apparatus of claim 1, wherein stoppers brought into close contact with one end and another end of the skid are positioned at opposite ends of the linear shuttle, respectively, and a pusher that is raised and lowered by driving of a cylinder is connected to the stoppers.

9. The battery cell stacking apparatus of claim 1, wherein the first loading apparatus, the second loading apparatus, and the third loading apparatus each comprise:
a linear frame configured to move along a linear rail;
a plurality of grippers mounted at a lower portion of the linear frame and configured to use vacuum suction to secure a battery cell or a pad.

10. The battery cell stacking apparatus of claim 1, wherein the third loading apparatus has a pad magazine, in which pads are loaded to be picked up by the third loading apparatus, arranged at a rear of the third loading apparatus.

11. The battery cell stacking apparatus of claim 10, wherein a hot-melt application gun configured to apply a hot-melt adhesive on the pads stacked in the skid during the linear shuttle moving left and right is arranged above the linear shuttle.

12. The battery cell stacking apparatus of claim 1, wherein a lifting apparatus configured to support and lift the battery cells stacked in the skid through open holes formed in the linear shuttle and in the skid, respectively, is arranged below the linear shuttle.

13. The battery cell stacking apparatus of claim 12, wherein the lifting apparatus comprises:
a fixed frame fixed at a position below the linear shuttle;
a lifting frame arranged below the fixed frame;
a drive motor mounted on the lifting frame;
a lead screw mounted at a bottom of the fixed frame and engaged with a gearbox of the drive motor; and
a lifting bar mounted on the lifting frame and configured to support and lift the battery cells stacked in the skid while being raised and lowered through the open holes formed in the linear shuttle and the skid.

14. The battery cell stacking apparatus of claim 1, wherein a first elevator configured to lower the skid with an empty interior as the battery cells that have completed being stacked in the skid are picked up by a robot is arranged at a rear end portion of the linear conveyor.

15. The battery cell stacking apparatus of claim 14, wherein a lower linear conveyor configured to return the skid with an empty interior discharged from the first elevator to a position below the front end portion of the linear conveyor is arranged below the linear conveyor.

16. The battery cell stacking apparatus of claim 15, wherein a second elevator configured to raise the skid with an empty interior, which has returned to the position below the front end portion of the linear conveyor, to an upper surface position of the front end portion of the linear conveyor is arranged at an end portion of the lower linear conveyor.

17. A battery cell stacking apparatus comprising:
a skid configured to support a stack of battery cells and pads;
a plurality of loading apparatuses configured to deposit battery cells and pads onto the skid to form the stack; and
a servo-controlled vertical lift mechanism operatively coupled to the skid, wherein the vertical lift mechanism is configured to adjust an elevation of the skid downward after a battery cell or a pad is deposited thereby maintaining a top surface of the stack at a substantially constant vertical height for receiving a subsequent battery cell or pad.

18. The battery cell stacking apparatus of claim 17, wherein the servo-controlled vertical lift mechanism adjusts the elevation of the skid based on a predetermined thickness of the battery cell or the pad being deposited.

19. A battery cell stacking apparatus comprising:
a conveyance system configured to move a skid to a plurality of loading stations; and
at least one loading apparatus positioned at one of the loading stations, the at least one loading apparatus comprising a gripper for picking and placing a battery cell, wherein the gripper includes a multi-axis compliance mechanism configured to cushion the battery cell against forces along at least one vertical axis and at least one horizontal axis during placement of the battery cell onto the skid.

20. The battery cell stacking apparatus of claim 11 wherein the multi-axis compliance mechanism comprises a plurality of spring-loaded cushions that provide compliance to prevent shock-induced damage to the battery cel as it makes contact with an adjacent component in the skid.
